(19) United States
(12) Patent Application Publication
(10) Pub. No.: US 2015/0212499 A1
(43) Pub. Date: Jul. 30, 2015

(54) ELECTRONIC CONTROLLER AND METHOD FOR OPERATING AN ELECTRON

(71) Applicant: HIRSCHMANN AUTOMATION AND CONTROL GMBH, Neckartenzlingen (DE)

(72) Inventor: Robert Tordy, Hasslock (DE)

(21) Appl. No.: 14/414,478

(22) PCT Filed: Jun. 6, 2013
(86) PCT No.: PCT/EP2013/061699

§ 371 Date: Jan. 13, 2015

(30) Foreign Application Priority Data
Aug. 17, 2012 (DE) 10 2012 214 656.3

(51) Int. Cl. G05B 15/02

(52) U.S. Cl. CPC G05B 15/02

(57) ABSTRACT

Method for operating an electronic controller to which at least sensors and/or actuators are connected, wherein the controller is installed immovably at an installation location, characterized in that at least one sensor is used to ascertain the installation location of the controller, and the ascertained installation location is taken as a basis for deciding whether or not the controller can be operated.

The invention relates to an electronic controller and a method of operating such an electronic controller, in accordance with the features of the preamble of the independent patent claims.

Electronic controllers to which sensors and/or actuators and further devices (such as input and/or output devices) are connected are well known. For example, such electronic controllers are used in motor vehicles where they record operating parameters of the vehicle by means of sensors (for example, the pressing of an accelerator pedal for the purpose of requesting power) and control actuators (for example, actuators that control fuel injection and the like in the engine of the vehicle) in accordance with corresponding internal data processing in which the recorded sensor signals are taken into account. The same applies to electronic controllers in industrial applications, such as in work vehicles or work devices, for example mobile or stationary cranes that likewise have sensors and actuators via which the crane operator controls the operation of the crane. The last-mentioned application is governed by safety aspects, because not every command that the crane operator would like to perform can be performed by the crane or by the control system of the crane, because otherwise there would be a risk of persons or property being harmed or endangered by impermissible movement of the load, for example. There is also a risk that the work device itself could be endangered by an impermissible movement as a consequence of an impermissible control command (for example, the work device could tip over). Therefore, it is important to take safety aspects into account in the specification of a controller and a method of operating such a controller. This means that a malfunction caused by the controller or the failure of the controller itself must be avoided under all circumstances. In order to prevent this, electronic controllers having at least one sensor that detects an operating parameter of the controller itself have already become known. This operating parameter is the operating temperature, in particular the operating temperature within a housing of the controller. In this way, the case in which overheating of the controller, more precisely overheating of the electronics within a housing of the controller, leads to a malfunction or to a failure of the controller is avoided.

Such controllers are typically installed in a specified installation location, and it should be ensured that the controller functions faultlessly in this installation location. This means that the installation location of the controller is selected with regard to the operating temperature of the controller in such a way that, for example, passive ventilation (without a fan) or active ventilation (with a fan) ensures an exchange of air between the outside environment of the housing and the interior of the housing so that a specifiable upper operating temperature is not exceeded. In this way, it is actually ensured that malfunctions and failures of the controller as a consequence of impermissible temperatures are avoided or ruled out. Nevertheless, there is often a risk that an electronic controller is not properly installed in the installation location of the electronic controller. This risk exists in particular when the controller has been exchanged after a defect and the possibility of installing the exchanged controller in an installation position different from the specified installation position exists. In this case, there can be a risk that the exchanged controller or a new controller is not properly installed in the installation location of the controller. Because of this improper installation, there can be a risk, for example, that the air convection or air circulation for the purpose of removing heat from the interior of the housing of the controller to the outside is no longer sufficient or no longer occurs at all, so that there is a risk of overheating, which results in the improperly installed controller having malfunctions or failures as a consequence of overheating.

Therefore, the object of the invention is to provide an electronic controller and a method of operating such an electronic controller that effectively avoid the disadvantages described above.

The object is attained by the features of the independent patent claims.

With regard to the method according to the invention for operating an electronic controller, the installation location of the controller is determined by at least one sensor (i.e. exactly one sensor or more than one sensor) and a decision as to whether the controller may operate or not is made in dependence on the determined installation location. Because the installation location is determined by at least one sensor, it can be determined whether the controller has been properly or improperly installed in the intended installation location of the controller. If it is determined by the sensor signal that the controller has not been properly installed, the controller is constrained against operating without restrictions. If, for example, the controller was installed in such a way that the controller was improperly rotated about one of the axes of the controller, so that a ventilation opening was closed, for example, and air circulation is no longer possible, it is determined that overheating of the controller can occur during operation of the controller and unrestricted operation is no longer ensured. At this point, the temperature in the interior of the housing of the controller could be detected by a further sensor, specifically a temperature sensor, for example. If the improper installation location was detected by the position sensor but at the same time the temperature sensor has not determined that a specified maximum value has been reached or exceeded, it can be decided by corresponding logic that the controller nevertheless may be operated without restrictions or, if applicable, with restrictions. This means that, in general, at least one further sensor can be added in addition to the sensor according to the invention for determining the installation location of the controller and at least the signals of the two sensors (or, if applicable, further sensors) are logically combined to decide if the controller may be operated or not.

As described above, the sensor is designed to determine the installation location of controller. However, the installation location of the controller should not be understood as only the installation location of the controller with respect to the application of the controller (for example, in a stationary work device or a mobile work vehicle). The term “installation location” should also be understood as an installation location relative to the location of use of the device or of the vehicle in which the controller is installed. For example, controllers properly installed in the device or the vehicle can be operated up to a certain height (usually relative to sea level) without additional provisions without a risk of restrictions during the operation of the controller caused by the air pressure present there. If, however, it turns out that restrictions of the controller are to be expected as a consequence of a greater height, the at least one sensor can be designed accordingly to detect the height of the installation location (relative to sea level). If it is determined that the height of the location of use of the device or of the vehicle exceeds a specifiable height, it can be decided whether the controller may not be operated at all, may be operated with restrictions, or may be operated without restrictions. In this case also, the height signal of the sensor can be logically combined with at least one further signal. For example, the height signal could be logically combined with a temperature signal. As an alternative to or in addition to the temperature signal, a further signal is added, such as a signal that represents the relative humidity, or even further signals (such as air pressure and others). The above-described signals and possibly further signals can be stored in a characteristic map of two, three, or more dimensions, from which characteristic map it can be determined whether the controller a: may be operated without restrictions or may not be operated at all or b: may be operated without restrictions, may be operated with restrictions, or may not be operated at all.

In a further development of the invention, if it has been determined that the controller may not be operated at the installation location, operation is completely interrupted or restricted operation is permitted. This has the advantage that, if an improper installation location has been determined, the ongoing operation of the controller or the putting into operation of the controller is not necessarily interrupted or prevented, but rather restricted operation that is not safety-critical can also be permitted. This can be implemented in particular by the above-described actions (for example logically combining several signals, reading out a characteristic map, and the like).

In a further development of the invention, the at least one sensor independently determines the installation position of the controller in the installation location of the controller. The sensors can be, for example, positions sensors, tilt sensors, and the like that are installed in or connected to the controller in order to determine the installation location. In the simplest embodiment, a switch can be installed on the device or vehicle, for example, and the switch is actuated if the controller has been properly installed in the installation location of the controller. If the controller is not properly installed, the switch is thus automatically not actuated, so that the output signal of the switch can be used to evaluate if the controller was installed properly or improperly.

In a further development of the invention, the at least one sensor determines the installation position of the controller in the installation location of the controller through an external positioning system. For example, a global positioning system (GPS) is considered here. Such an external positioning system is preferably used if the height of the installation location relative to a reference point (for example, above or below sea level) should be detected. Such an external positioning system is also used if the controller and the software stored in the controller for controlling the device or the vehicle has a country-specific design. If, for example, such a controller programmed in a country-specific manner may be operated only in Europe and it is determined by the at least one sensor by the external positioning system that the controller or the vehicle or the device in which the controller is installed is located not in Europe (but rather in America or Asia, for example), the putting into operation or the operation of the controller can be prevented or interrupted. The reason for this is that, because of different country-specific designs of controllers, it may be that the country-specific programming is permissible in one country or region but not in another country or region. In this way also, safety-critical uses of devices or vehicles are also effectively avoided.

In a further development of the invention, the design conditions of the controller are taken into account in the decision as to whether the controller may be operated in the installation location or not. For example, if a controller has an approximately rectangular housing and there are openings for the exchange of air only on one of the lateral end faces and the controller is improperly installed with the opening on a base of the vehicle or device (so that the opening is closed), this design condition of the controller can be determined by the sensor signal that represents the installation location and can be taken into account in the decision as to whether the controller may be operated in this installation situation in the installation location or not. In the stated example, it is decided that the controller may not be operated at all because of the closure of the opening for exchanging air. If, however, the improper installation position is determined and at the same time the signal representing the installation location is logically combined with a further signal (for example, a signal of a temperature sensor), it can also be decided that the controller may be operated without restrictions or with restrictions. As long as the temperature detected in the interior of the housing of the controller by the temperature sensor does not exceed a maximum value, for example, it can be decided that the controller may be operated without restrictions despite the improper installation of the controller in the installation location of the controller.

Alternatively or in addition thereto, it is provided that ambient conditions in the installation location are taken into account in the decision as to whether the controller may be operated in the installation location or not. The example in which the housing of the controller has an opening for exchanging air between the interior and the outside surroundings of the controller is used again here for purposes of illustration. If it is determined by the sensor according to the invention for determining the installation location that the controller has been improperly installed (because the opening for exchanging air is closed), the outside temperature of the controller can be detected at the same time. If the determined outside temperature is within a range in which the outside temperature does not cause a maximum temperature to be exceeded within the housing, it can be decided that the controller may be operated without restrictions or, if applicable, with restrictions. However, the temperature is not the only ambient condition. Alternative or additional ambient conditions could be the height of the installation location (relative to a reference point), the humidity, the country or the region, or further ambient conditions.

Taking into consideration the variants described above of the method according to the invention for operating an electronic controller, which variants differ from each other and/or supplement each other, such an electronic controller, to which sensors and/or actuators (and possibly further elements) are connected, the controller being immovably installed in an installation location, according to the invention the controller has at least one sensor, and the at least one sensor is suitable and designed for the installation location to be determined and for a decision as to whether the controller may be operated or not to be made in dependence on the determined installation location. Here also, the sensor and the method, in which the determined installation location is taken into account, are designed and suitable for a decision as to whether the controller may be operated without restrictions, may be operated with restrictions, or may not be operated at all to be made. The same also applies to the initial putting into operation of such a controller, so that, in this case also, it can be decided whether the controller immovably installed in the installation location of the controller may be put into operation without restrictions, may be put into operation with restrictions, or may not be put into operation at all.

The method described above for operating a controller and such a controller are especially preferably used for stationary work devices (such as cranes, dockside cranes, or the like) or mobile work vehicles (such as mobile cranes). The method according to the invention can be used especially advantageously in this application, because the devices and vehicles have modes of operation that are relevant to safety. However, the use is not limited to the above-described fields.

1. A method of operating an electronic controller to which at least sensors and/or actuators are connected, the controller being immovably installed in an installation location, wherein the installation location of the controller is determined by at least one sensor and a decision as to whether the controller may be operated or not is made in dependence on the determined installation location.

2. The method according to claim 1, wherein the operation is completely interrupted or restricted operation is permitted if it has been determined that the controller may not be operated in the installation location.

3. The method according to claim 1, wherein the at least one sensor independently determines the installation position of the controller in the installation location of the controller.

4. The method according to claim 1, wherein the at least one sensor determines the installation position of the controller in the installation location of the controller through an external positioning system.

5. The method according to claim 1, wherein the design conditions of the controller are taken into account in the decision as to whether the controller may be operated in the installation location or not.

6. The method according to claim 1, wherein ambient conditions in the installation location are taken into account in the decision as to whether the controller may be operated in the installation location or not.

7. A method of operating an electronic controller to which at least sensors and/or actuators are connected, the controller being immovably installed in an installation location, wherein the controller comprises at least one sensor that is suitable and designed for the installation location to be determined and for a decision as to whether the controller may be operated or not to be made in dependence on the determined installation location.

8. The controller according to claim 7, wherein the sensor is suitable and designed for independently determining the installation position of the controller in the installation location of the controller.

9. The controller according to claims 7, wherein the sensor is suitable and designed for determining the installation position of the controller in the installation location of the controller through an external positioning system.

10. The controller according to claim 7, wherein the controller is a component of a stationary work device or of a mobile work vehicle for controlling the functions of the work device or of the work vehicle.
